(19) United States
(12) Patent Application Publication
(10) Pub. No.: US 2006/0011475 A1
(43) Pub. Date: Jan. 19, 2006

(54) IN-SITU MONITORING AND CONTROLLING SYSTEM FOR CHEMICAL VESSELS OR TANKS

(76) Inventors: Hung-Hsiang Lin, Tai-Chung City (TW); Kun-Yang Lin, Miao- Li Hsien (TW); Shun-Li Hong, Chang-Hua Hsien (TW); Yuh-Lang Lee, Tai-Nan City (TW); Yu-Zen Shen, Nan-Tou City (TW)

Correspondence Address: NORTH AMERICA INTELLECTUAL PROPERTY CORPORATION, P.O. BOX 506, MERRIFIELD, VA, 22116, US

(21) Appl. No.: 10/710,271

(22) Filed: Jun. 30, 2004

(51) Int. Cl. G01N 27/26

(52) U.S. Cl. 204/404

(57) ABSTRACT

An in-situ and real-time monitoring and controlling system for chemical vessels, tanks, reactors or the like is disclosed. The chemical vessels, tanks, or reactors are employed to contain high-purity corrosive chemicals such as acids, alkaline liquids or the like. The monitoring and controlling system encompasses a vessel including a conductive shell and insulating interior lining coated therein. A robust detection electrode is dipped into the chemical liquid contained by the vessel. The detection electrode is electrically connected to a measurement means such as an ohmmeter that is mounted outside the vessel. The measurement means is further electrically connected to the conductive shell. When the interior lining is pitted due to the chemical attack by the chemical liquid and the chemical liquid contacts the conductive shell, the measurement means promptly receives a corresponding signal. According to one preferred embodiment, the measurement means is further connected to a controller unit that can control a semi-conductor-processing unit.

### BACKGROUND OF INVENTION

1. Field of the Invention

The present invention relates to a monitoring and controlling system for chemical vessels or tanks. More particularly, the present invention relates to an in-situ and real-time semiconductor process monitoring and controlling system capable of effectively monitoring the integrity of an interior lining of chemical vessels and controlling the wet processing unit, thereby promoting quality and yield of the semiconductor process.

2. Description of the Prior Art

Chemical supply system is essential to the semiconductor manufacturing. Typically, various processing chemicals are shipped from a dock or a chemical provider to a utility zone of a semiconductor factory by means of tank truck carriers. The tank truck carrier then discharges the liquidized processing chemicals to respective storage tanks or vessels via suitable piping systems. To maintain production yield of the semiconductor manufacturing, it is always required to provide processing chemicals of the highest industry standards.

As known in the art, semiconductor processing and manufacturing generally requires numerous manufacturing steps to produce a desired integrated circuit chip. The numerous steps may include etching, photoresist stripping, prediffusion cleaning and so on. Corrosive chemicals such as oxidants, strong acids or alkaline liquids may be frequently used in different stages in the semiconductor manufacturing and any changes in the chemicals could significantly affect product outcomes. The corrosive chemicals are ordinarily stored in the specifically designed tanks lined with special materials. Though these tanks are theoretically corrosion-proof containers, periodic manual sampling and off-line analysis are still put on routine lists to make sure the quality of the stored chemicals. However, it has been found that in some cases undesired trace metal contamination happens due to rouging or pitting of the interior lining of the storage tanks.

Unfortunately, the conventional periodic sampling and off-line analysis procedures seem does not help much to reduce damages caused by the contaminated processing chemicals. The above-described manual sampling and off-line analysis method is ineffective and costly. Further, since the chemicals used in the manufacturing steps are often quite toxic to humans, care must be taken to minimize the risk of exposure to the plant personnel working in the manufacturing facility.

Hitherto, there is still no effective monitoring system capable of in-situ and real-time monitoring the integrity of the lined tanks, thereby providing the facility operators or QA/QC managers with newest quality status of the processing chemicals in a timely manner. Clearly, a need exists for such an in-situ monitoring system.

### SUMMARY OF INVENTION

It is therefore the primary object of the present invention to provide an inexpensive, in-situ, continuous, real-time corrosion monitoring system for various chemical vessels such as stationary storage tanks in the factories or those vessels for transportation purposes such as tank truck carriers.

It is another object of the present invention to provide an effective, in-situ and real-time semiconductor process monitoring and controlling system capable of monitoring the integrity of the interior lining of a chemical vessel and controlling the semiconductor processing unit, thereby promoting quality and yield of the semiconductor process.

To achieve the above objects, in accordance with the claimed invention, an in-situ corrosion monitoring system is provided. The in-situ corrosion monitoring system includes a chemical vessel for containing chemical liquid. The chemical vessel comprises a conductive shell body and an insulating interior lining coated therein. The interior lining has potential of being attacked by the chemical liquid. A robust detection electrode is immersed in the chemical liquid. A measurement means such as an ohmmeter is electrically connected to the detection electrode. The measurement means is also electrically connected to the conductive shell body. When the interior lining is damaged or pitted due to chemical attack by the chemical liquid and the chemical liquid thus contacts the conductive shell body, the measurement means receives a corresponding signal.

From one aspect of this invention, an in-situ and real-time semiconductor process monitoring and controlling system is provided. The semiconductor process monitoring and controlling system includes a processing vessel for accommodating at least a semiconductor wafer to be wet-treated; a wafer transferring means for loading or un-loading the semiconductor wafer into or out of the processing vessel; and a chemical vessel for containing chemical liquid and supplying the chemical liquid to the processing vessel through a piping system. The chemical vessel comprises a conductive shell body and an insulating interior lining coated therein. The interior lining has potential of being attacked by the chemical liquid. A robust detection electrode is immersed in the chemical liquid. A measurement means is electrically connected to the detection electrode. The measurement means is further electrically connected to the conductive shell body. When the interior lining is damaged or pitted due to chemical attack by the chemical liquid and the chemical liquid thus contacts the conductive shell body, the measurement means promptly receives a corresponding signal. The semiconductor process monitoring and controlling system further includes a controller unit connected to the measurement means. Once the measurement means receives the corresponding signal, the controller unit sends a first control signal to the wafer transferring means.

Other objects, advantages and novel features of the invention will become more clearly and readily apparent from the following detailed description when taken in conjunction with the accompanying drawings.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is a schematic diagram illustrating a corrosion monitoring system for chemical vessels containing corrosive chemicals in accordance with one preferred embodiment of the present invention;

FIG. 2 is a schematic diagram showing the monitoring data and real-time curve plot continuously measured by the measurement means of the corrosion monitoring system according to the preferred embodiment of this invention;

FIG. 3 is a schematic diagram showing an in-situ and real-time semiconductor process monitor and control system capable of continuously monitoring the quality of chemical liquids used in a semiconductor wet processing unit in accordance with a second preferred embodiment of this invention; and

FIG. 4 illustrates a third preferred embodiment according to the present invention.

### DETAILED DESCRIPTION

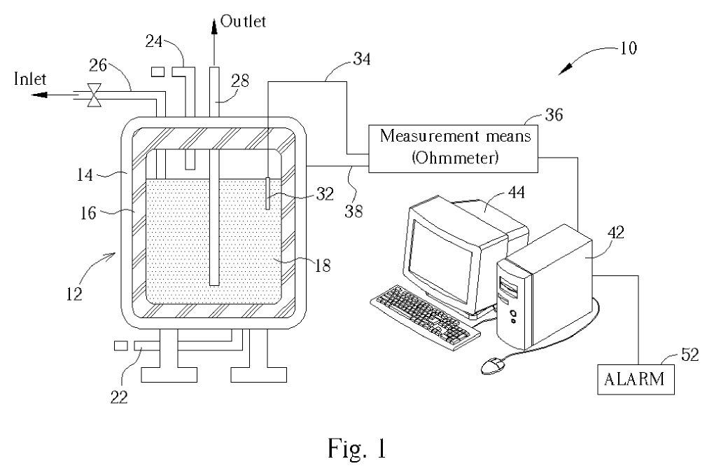

Please refer to FIG. 1. FIG. 1 is a schematic diagram illustrating a corrosion monitoring system 10 for chemical vessels or chemical tanks in accordance with one preferred embodiment of the present invention. Hereinafter, the term: “vessel” or “chemical vessel” refers to those containers including “tank”, “drum”, “tube” “cylinder”, “reactor” or whatever employed to contain corrosive liquid chemicals either for storage/transportation purposes or for processing purposes. As shown in FIG. 1, the corrosion monitoring system 10 comprises a chemical vessel 12 comprising a conductive shell body 14 coated with an insulating interior lining 16. The chemical vessel 12 contains corrosive chemical liquid 18 in contact with the interior lining 16. The shell body 14 may be made of metal materials such as stainless steel, carbon steel, coated steel, aluminum or alloys.

It is to be understood that various types of piping or piping elements such as valves, gauges, or analytical instruments for different purposes may be installed on the shell body 14, which are not germane to this invention and are therefore not explicitly shown in the figures. In general, the shell body 14 is typically, but not necessarily, installed with a drain 22, a vent pipe 24, an inlet pipeline 26, and an outlet pipeline 28, but not limited thereto. It is to be understood that the sizes and number of these pipelines connected to the shell body 14 as well as the shell body 14 depend upon the practical requirements on site.

The interior lining 16 of the chemical vessel 12 is made of corrosion-proof insulating materials such as fluoropolymer resins. Preferably, the interior lining 16 is made of poly-tetra-fluoroethylene (PTFE) and/or per-fluoroalkoxy (PFA). However, other Teflon materials such as ethylene tetra-fluoroethylene (ETFE) or fluorinated ethylene propylene (FEP) may be used.

The corrosive chemical liquid 18, by way of example, may be industry-grade (or higher grade) sulfuric acid, nitric acid, hydrochloric acid, hydrofluoric acid, hydrogen peroxide, ferric chloride, halogenated organics or other corrosive chemicals, but not limited thereto.

The present invention corrosion monitoring system 10 features a robust detection electrode 32 installed inside the chemical vessel 12. The robust detection electrode 32 is immersed in the corrosive chemical liquid 18 contained by the chemical vessel 12. Preferably, the detection electrode 32 is made of corrosion-resistant materials such as platinum (Pt) or the like. As shown in FIG. 1, the detection electrode 32 is electrically connected to a measurement means 36 installed outside the chemical vessel 12 via a conductive wiring 34. According to the preferred embodiment of this invention, the measurement means 36 is an ohmmeter. The ohmmeter has a measurement range of about 1 M Ohm to 40 G Ohm, and an output voltage of about 50 volts to 200 volts, but not limited thereto. The measurement means 36 is electrically connected to the conductive shell body 14 via a conductive wiring 38. A computer unit 42 equipped with a monitor 44 may be provided to process and store data transmitted from the measurement means 36. The computer unit 42 may be further connected with an alarm device 52.

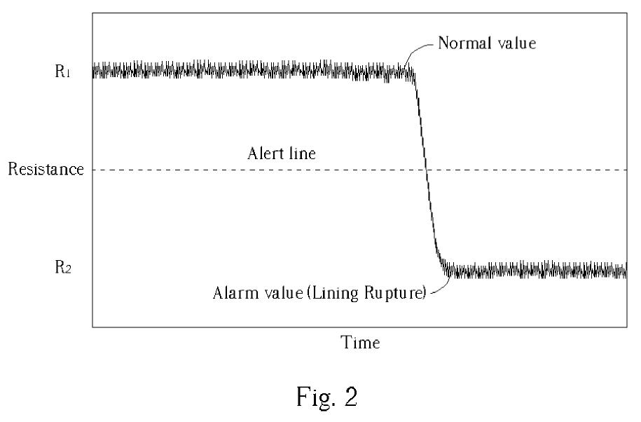

Please refer to FIG. 2. FIG. 2 is a schematic diagram showing the monitoring data and real-time curve plot continuously measured by the measurement means 36, which are demonstrated on the monitor 44 of the corrosion monitoring system 10 according to the preferred embodiment of this invention. Since the interior lining 16 of the chemical vessel 12 is made of insulating resins such as PTFE, a high-level resistance R₁ is continuously detected by the measurement means 36 (an ohmmeter in this case) in a normal status. When the interior lining 16 is damaged or pitted due to the chemical attack by the chemical liquid and the chemical liquid contacts the conductive shell body 14, the measurement means 36 promptly receives a corresponding signal: a relatively low-level resistance R₂. Once the measurement means 36 receives the low-level signal R₂, the computer unit 42 transmits a signal to the alarm device 52 and triggers the alarm system to warn the operators. In FIG. 2, a reference alert line is also illustrated. The low-level signal R₂ may be set a percentage lower than the reference alert line.

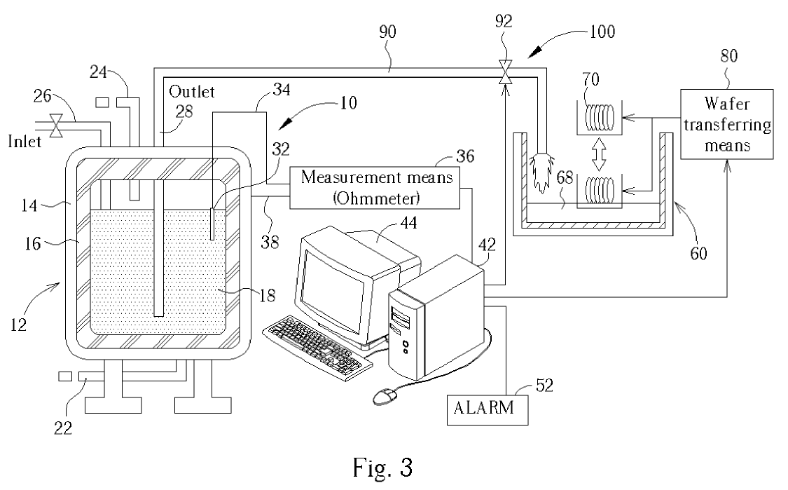

Please refer to FIG. 3. FIG. 3 is a schematic diagram showing an in-situ and real-time semiconductor process monitor and control system 100 capable of continuously monitoring the quality of chemical liquids used in a semiconductor wet processing unit in accordance with a second preferred embodiment of this invention, wherein like numerals designate similar or the same parts, elements or devices. The monitor and control system 100 comprises a stationary processing vessel 60 that is used to contain aqueous chemical solution 68 or agents with specific recipes and is adapted to accommodate wafers 70 to be wet-treated. The wet process may be a wafer cleaning process or a wet etching process, but not limited thereto. The processing vessel 60 may be single-wafer type or multi-wafer type. Besides, the processing vessel 60 may be hermetic or open to air.

According to the second preferred embodiment, the monitor and control system 100 further comprises a wafer transferring means 80 such as a robotic arm or a mechanical lifting device that is used to load or un-load the wafers 70. For a batch type wet process, conventionally, the wafers are arranged in a wafer lot, and the mechanical lifting device lifts the wafer lot that have been dipped in the aqueous chemical solution 68 for a prescribed time period. The chemical liquid 18 is transferred from the chemical vessel 12 to the processing vessel 60 through a piping system 90.

According to the second preferred embodiment, the monitor and control system 100 comprises the corrosion monitor system 10 including the storage chemical vessel 12 that is used to store various corrosive chemical liquids 18. Likewise, the storage chemical vessel 12 comprises a conductive shell body 14 and an insulating lining 16 therein. Depending on practical needs, various types of piping or piping elements such as valves, gauges, nozzles or analytical instruments for different purposes may be installed on the shell body 14. Generally, the shell body 14 is installed with a drain 22, a vent pipe 24, an inlet pipeline 26, and an outlet or exhaust pipeline 28, but limited thereto. The aforesaid piping system 90 is connected to the outlet pipeline 28.

The shell body 14 may be made of metal materials such as stainless steel, carbon steel, coated steel, aluminum or alloys. The interior lining 16 of the chemical vessel 12 is made of corrosion-proof insulating materials such as fluoropolymer resins. Preferably, the interior lining 16 is made of poly-tetra-fluoroethylene (PTFE) and/or perfluoroalkoxy (PFA). However, ethylene tetra-fluoroethylene (ETFE) or fluorinated ethylene propylene (FEP) may be used.

A robust detection electrode 32 is installed inside the storage chemical vessel 12. The robust detection electrode 32 is immersed in the corrosive chemical liquid 18 contained by the storage chemical vessel 12. The corrosive chemical liquid 18, by way of example, may be industry-grade (or higher grade) sulfuric acid, nitric acid, hydrochloric acid, hydrofluoric acid, hydrogen peroxide, ferric chloride, halogenated organics or other corrosive chemicals. The detection electrode 32 is made of corrosion-resistant materials such as platinum (Pt) or the like. The detection electrode 32 is electrically connected to a measurement means 36 installed outside the chemical vessel 12 via a conductive wiring 34. According to the second preferred embodiment of this invention, the measurement means 36 is an ohmmeter. The ohmmeter has a measurement range of about 1M Ohm to 40 G Ohm, and an output voltage of about 50 volts to 200 volts, but not limited thereto. The measurement means 36 is electrically connected to the conductive shell body 14 via a conductive wiring 38. A computer controller unit 42 equipped with a monitor 44 may be provided to process and store data transmitted from the measurement means 36. The computer controller unit 42 may be further connected with an alarm device 52.

According to the second preferred embodiment of this invention, the computer controller unit 42 of the semiconductor process monitor and control system 100 is further connected to an automatic on/off valve 92 that is installed in the piping system 90 and connected to the wafer transferring means 80. When the interior lining 16 of the storage chemical vessel 12 is pitted due to the chemical attack by the chemical liquid and the chemical liquid 18 contacts the conductive shell body 14, the measurement means 36 promptly receives a corresponding signal such as a low-level resistance signal. Once the measurement means 36 receives the low-level signal, the computer controller unit 42 transmits a signal to the alarm device 52 and triggers the alarm system to warn the operators. Simultaneously, the computer controller unit 42 sends a control signal to the wafer transferring means 80 to stop loading the wafers 70 into the processing vessel 60, thereby minimizing the damage. Besides, the computer controller unit 42 sends a control signal to the automatic on/off valve 92 to cut off the supply path between the storage chemical vessel 12 and the processing vessel 60 so as to prevent contaminated chemical liquids from flowing into the wet processing unit.

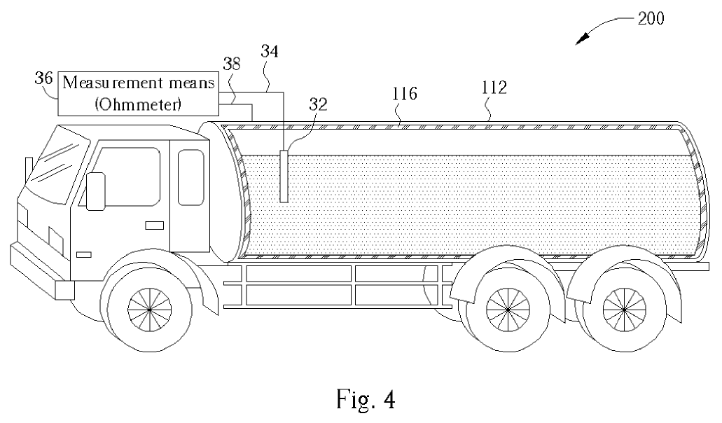

Please refer to FIG. 4. FIG. 4 illustrates a third preferred embodiment according to the present invention. The present invention can be applied to chemical vessels for transportation purposes such as tank truck carriers or the like. As shown in FIG. 4, the monitor system 200 includes a vehicle chemical vessel 112 lined with insulating materials such as PTFE and/or PFA. The vehicle chemical vessel 112 is fixed on a truck. The vehicle chemical vessel 112 is used to contain and transport corrosive chemical liquids, for example, sulfuric acid, nitric acid, hydrochloric acid, hydrofluoric acid, hydrogen peroxide, ferric chloride, halogenated organics or other corrosive chemicals.

Likewise, a robust detection electrode 32 is installed inside the vehicle chemical vessel 12. The robust detection electrode 32 is immersed in the corrosive chemical liquid 18 contained by the vehicle chemical vessel 12. The detection electrode 32 is electrically connected to a measurement means 36 installed outside the vehicle chemical vessel 112 via a conductive wiring 34. According to this invention, the measurement means 36 is an ohmmeter. The ohmmeter may have a measurement range of about 1M Ohm to 40 G Ohm, and an output voltage of about 50 volts to 200 volts, but not limited thereto. The measurement means 36 is electrically connected to the conductive outer shell of the vehicle chemical vessel 112 via a conductive wiring 38. A vehicle computer unit equipped with an LCD monitor may be provided to process, store and display data transmitted from the measurement means 36.

Those skilled in the art will readily observe that numerous modification and alterations of the invention may be made while retaining the teachings of the invention. Accordingly, the above disclosure should be construed as limited only by the metes and bounds of the appended claims.

What is claimed is:

1. An in-situ corrosion monitoring system, comprising:
a chemical vessel for containing chemical liquid, said chemical vessel comprising a conductive shell body and an insulating interior lining coated therein, wherein said interior lining has potential of being attacked by said chemical liquid;
a robust detection electrode immersed in said chemical liquid; and
a measurement means being electrically connected to said detection electrode, wherein said measurement means is also electrically connected to said conductive shell body, and when said interior lining is damaged or pitted due to chemical attack by said chemical liquid and said chemical liquid thus contacts said conductive shell body, said measurement means receives a corresponding signal.

2. The in-situ corrosion monitoring system according to claim 1 wherein said conductive shell body is made of stainless steel or carbon steel.

3. The in-situ corrosion monitoring system according to claim 1 wherein said conductive shell body is made of aluminum.

4. The in-situ corrosion monitoring system according to claim 1 wherein said insulating interior lining comprises fluoropolymer resin materials.

5. The in-situ corrosion monitoring system according to claim 4 wherein said fluoropolymer resin materials comprise poly-tetra-fluoroethylene (PTFE).

6. The in-situ corrosion monitoring system according to claim 4 wherein said fluoropolymer resin materials comprise per-fluoroalkoxy (PFA).

7. The in-situ corrosion monitoring system according to claim 1 wherein said robust detection electrode is made of corrosion-resistant materials.

8. The in-situ corrosion monitoring system according to claim 7 wherein said corrosion-resistant materials comprises platinum (Pt).

9. The in-situ corrosion monitoring system according to claim 1 wherein said measurement means is an ohmmeter.

10. The in-situ corrosion monitoring system according to claim 9 wherein said ohmmeter has a measurement range of about 1M Ohm to 40 G Ohm.

11. The in-situ corrosion monitoring system according to claim 1 wherein said corresponding signal is a resistance signal.

12. An in-situ and real-time semiconductor process monitoring and controlling system, comprising:
a processing vessel for accommodating at least a semiconductor wafer to be wet-treated;
a wafer transferring means for loading or un-loading said semiconductor wafer into or out of said processing vessel;
a chemical vessel for containing chemical liquid and supplying said chemical liquid to said processing vessel through a piping system, said chemical vessel comprising a conductive shell body and an insulating interior lining coated therein, wherein said interior lining has potential of being attacked by said chemical liquid; and
wherein a robust detection electrode is immersed in said chemical liquid; a measurement means is electrically connected to said detection electrode, said measurement means is further electrically connected to said conductive shell body; when said interior lining is damaged or pitted due to chemical attack by said chemical liquid and said chemical liquid thus contacts said conductive shell body, said measurement means receives a corresponding signal; and
a controller unit connected to said measurement means, wherein once said measurement means receives said corresponding signal, said controller unit sends a first control signal to said wafer transferring means.

13. The in-situ and real-time semiconductor process monitoring and controlling system according to claim 12 wherein said first control signal stops said wafer transferring means to load said wafer into said processing vessel.

14. The in-situ and real-time semiconductor process monitoring and controlling system according to claim 12 wherein said controller unit is further connected to an on/off valve device installed in said piping system, and once said measurement means receives said corresponding signal, said controller unit sends a second control signal to said on/off valve device.

15. The in-situ and real-time semiconductor process monitoring and controlling system according to claim 14 wherein said second control signal turn off said on/off valve device.

16. The in-situ and real-time semiconductor process monitoring and controlling system according to claim 12 wherein said measurement means is an ohmmeter.

17. The in-situ and real-time semiconductor process monitoring and controlling system according to claim 16 wherein said ohmmeter has a measurement range of about 1M Ohm to 40 G Ohm.

18. The in-situ and real-time semiconductor process monitoring and controlling system according to claim 12 wherein said insulating interior lining comprises fluoropolymer resin materials.

19. The in-situ and real-time semiconductor process monitoring and controlling system according to claim 18 wherein said fluoropolymer resin materials comprise poly-tetra-fluoroethylene (PTFE).

20. The in-situ and real-time semiconductor process monitoring and controlling system according to claim 18 wherein said fluoropolymer resin materials comprise per-fluoroalkoxy (PFA).
